(19) United States
(12) Patent Application Publication
(10) Pub. No.: US 2005/0094965 A1
(43) Pub. Date: May 5, 2005

(54) Methods and apparatus to improve the rate control during splice transitions

(76) Inventors: Jing Yang Chen, San Diego, CA (US); Robert Nemiroff, Carlsbad, CA (US); Siu-Wai Wu, San Diego, CA (US)

Correspondence Address: Kin-Wah Tong;Moser, Patterson & Sheridan, LLP, Suite 100, 595 Shrewsbury Ave., Shrewsbury, NJ, 07702, US

(21) Appl. No.: 10/935,694

(22) Filed: Sep. 7, 2004

Related U.S. Application Data
(60) Provisional application No. 60/500,408, filed on Sep. 5, 2003.

(51) Int. Cl. H04N 9/74

(52) U.S. Cl. 386/4

(57) ABSTRACT

The present invention provides improvements of the rate control method during the transitions at the splice point. In one embodiment, black frames and/or mute audio frames are inserted at the splice point.

### CROSS-REFERENCE TO RELATED APPLICATIONS

This application claims benefit of U.S. provisional patent application Ser. No. 60/500,408, filed Sep. 5, 2003, which is herein incorporated by reference.

### BACKGROUND OF THE INVENTION

1. Field of the Invention

The present invention relates generally to image processing. More specifically, the present invention provides improvements of the rate control method during the transitions at splice points.

2. Description of the Related Art

As digital multimedia information (e.g., a combination of text, image sequences and audio streams) continues to proliferate with consumers having systems and devices capable of receiving such digital multimedia information, it is often necessary to splice one or more secondary streams with one or more primary streams. One example is the transmission of a primary stream, e.g., a television program, that will be spliced with a plurality of secondary streams, e.g., a plurality of different advertisements at different times during the transmission of the primary stream. Additionally, since digital multimedia information requires a large number of bits to carry the digital information, it is often necessary to implement a spatial and a temporal prediction (e.g., motion compensation) encoding method such as Moving Pictures Expert Group (MPEG), H.261, H.263 and so on, to reduce the number of bits that must be stored and/or transmitted to a receiver. Although motion compensated encoding methods provide a very significant savings in the total number of bits that must be transmitted, it does create significant difficulties in the field of streams splicing due to the temporal dependency between frames. Namely, motion compensated encoding method generates reference frames, e.g., I and P frames that must be received first before frames that are dependent on these reference frames can be properly decoded. Thus, one cannot arbitrarily splice streams together when motion compensated encoding has been employed to generate the encoded streams.

To illustrate, splicing operations often create spliced streams having gaps caused by transitions between ending the primary stream and starting a secondary stream or ending a secondary stream and returning back to the primary stream. These gaps are due in part to the lack of time synchronization between the primary stream and the secondary stream. For example, when an advertisement stream has ended and it is time to return to the primary program, the timing may be such that it is necessary to wait for the next reference frame, e.g., an I frame, before the primary stream can resume. In other words, when the advertisement has ended, the primary stream may be in the middle of a Group of Pictures (GOP), so that it is necessary for a splicer to wait for the beginning of the next GOP before returning to the primary stream. This lack of time synchronization creates gaps in the transition points of spliced stream that must be addressed so that time synchronization is not lost with respect to the decoder. Additionally, in addressing these gaps in the spliced stream, a splicer or an encoder may impact the performance of a rate control method that is tasked with controlling the number of bits that will be transmitted on a variable rate channel.

Thus, there is a need in the art for a method and apparatus for improving splice transitions while maintain or improving rate control.

### SUMMARY OF THE INVENTION

The present invention provides improvements of the rate control method during the transitions at splice point. In certain splicing scenarios, the target audio decoder buffer delay established and maintained during the insertion of advertisement may not be large enough at the end of a splice operation (e.g., after an advertisement insertion), which may cause the audio decoder buffer to underflow during the splice transitions. In another scenarios, the video encoding bit rate may not matches the transmission data rate during the splice transition, which may cause the video decoder buffer to underflow during the splice transition.

In one embodiment, the general methods to avoid such problems are to reduce the sizes of the video and/or audio frames while increasing the transmission data rate during the splice transitions. The present invention discloses several methods to implement these general tactics, thereby improving the rate control during the splice transitions.

In one embodiment, black frames are inserted at the transition point of a spliced stream where a gap may exist between a primary stream and a secondary stream. The black frames can be inserted in a manner that will assist or enhance the rate control method. For example, the frame type of the sequence of inserted black frames can be made in a manner to assist the rate control method, e.g., having a sequence of black frames starting with an I frame and followed by P frames.

In one embodiment, the inserted black frames can be at a different resolution than the resolution of the frames in the primary and secondary streams. For example, if the resolution of the frames in the primary and secondary streams is at full resolution, then the resolution of the black frames can be at a resolution that is less than full resolution, e.g., half resolution and the like.

In one embodiment, a quantization scale, Q, can be selected for each black frame such that an optimal transmission or transport rate is maintained. Namely, since black frames are non-coded blocks, the quantization scale can be artificially selected to ensure that the transmission rate is properly maintained to support a proper transmission rate when the spliced stream returns to the primary stream.

In one embodiment, “mute” audio frames are inserted at the transition point of a spliced stream where a gap may exist between a primary stream and a secondary stream. The mute frames can be inserted in a manner that will assist or enhance the rate control method. For example, the audio bit rate for the mute audio frames can be made in a manner to assist the rate control method, e.g., choosing a lower bit rate for the mute audio frames.

In one embodiment, the audio transmission rate is selected in such a manner that will assist the rate control method. For example, the hardware time tag for the mute audio frames can be selected to increase the transmission rate in order to build up the decoder fullness during the transition point.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a block diagram of a transcoding system capable of performing the splicing operation and rate control method of the present invention;

FIG. 2 is a flowchart of a method for inserting black frames in accordance with the present invention;

FIG. 3 is a flowchart of a method for inserting mute audio frames in accordance with the present invention; and

FIG. 4 is a block diagram of the present digital encoding or transcoding system being implemented with a general purpose computer.

To facilitate understanding, identical reference numerals have been used, where possible, to designate identical elements that are common to the figures.

### DETAILED DESCRIPTION

In one embodiment of the present invention, the present improved rate control method is implemented to support digital program insertion. Namely, the present invention discloses broadly the insertion of one or more secondary streams into a primary stream to form a spliced stream. In one embodiment, the primary stream can be a television program, a movie, a video clip and so on, whereas the secondary streams can be short clips of advertisements. It should be noted that the content carried by the primary stream and the secondary stream are arbitrarily selected in accordance with a particular implementation and, as such, should not be interpreted as a limitation in the present invention.

Additionally, the present invention is discussed below as inserting one or more secondary streams into a primary stream. However, those skilled in the art will realize that the present invention is not so limited. The present invention can be broadly implemented where a plurality of streams are spliced together, i.e., there is no requirement that a primary stream is spliced with a plurality of secondary streams.

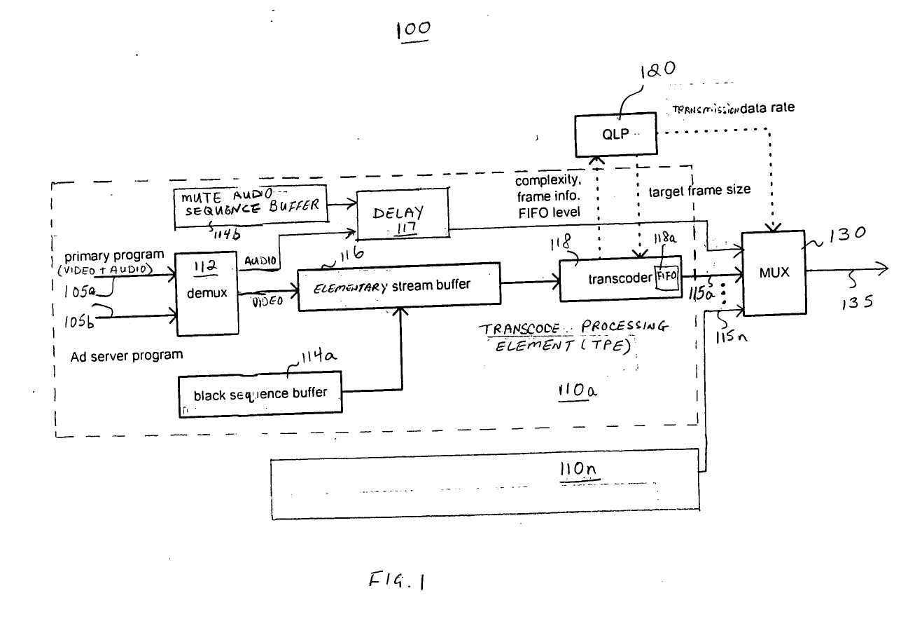

FIG. 1 illustrates a block diagram of a transcoding system 100 capable of performing the splicing operation and rate control method of the present invention. In one embodiment, the transcoding system 100 comprises at least one transcode processing element (TPE) 110a-n, a quantization level processor (QLP) 120 and a multiplexer 130.

In operation, one or more input elementary streams 105a-b are transcoded into an output stream on path 135. In one embodiment, each transcode processing element (TPE) 110 can be deployed to transcode elementary streams for a particular service or channel. As such, the multiplexer 130 may receive a plurality of transcoded streams on paths 115a-n and multiplexer 130 is tasked with multiplexing selecting all of said transcoded streams to form said output stream on path 135.

In one embodiment, a primary stream 105a may comprise elementary streams of at least one program. For example, the elementary streams may comprise one or more encoded video and audio streams associated with at least one program. Additionally, FIG. 1 illustrates one or more secondary streams 105b, e.g., from an advertisement server where the secondary streams comprise a plurality of advertisement streams. The primary stream and the secondary streams are received by a demultiplexer 112 where selective operation of the demultiplexer 112, e.g., by a controller (not shown) causes the video portions of the streams 105a-b to be spliced and stored temporarily in an elementary stream buffer 116. The elementary stream is then transcoded by the transcoder 118.

In contrast, the spliced audio portions of the two streams are stored temporarily in delay 117. It should be noted that the audio stream is not transcoded. The delay 117 also serves to adjust the PTS time stamps on the audio frames. The spliced audio stream from the delay 117 is then provided to multiplexer 130.

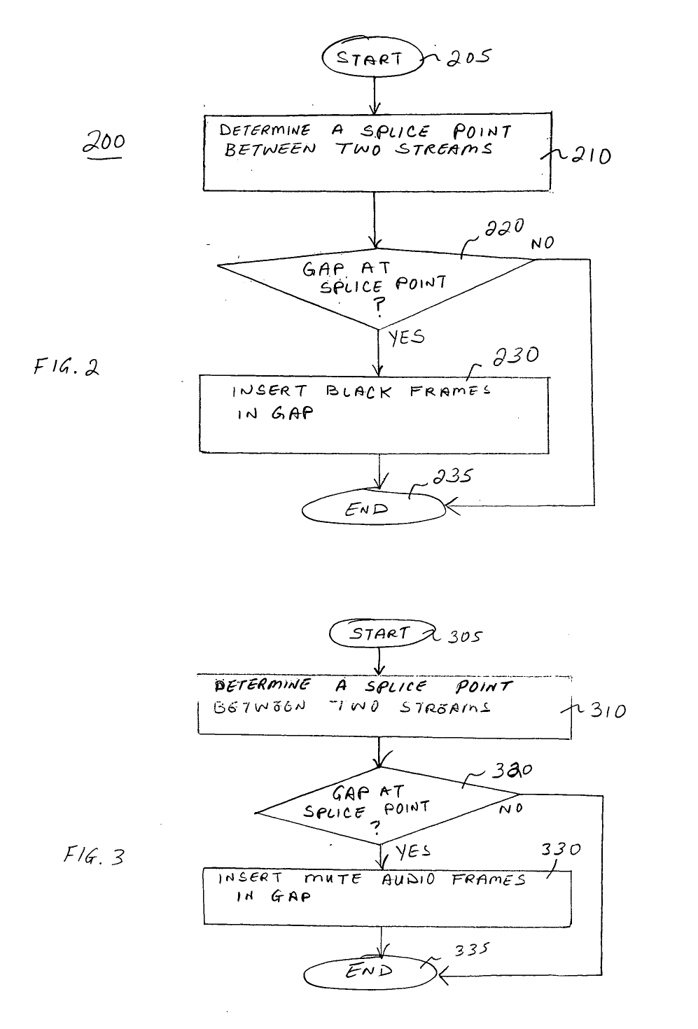

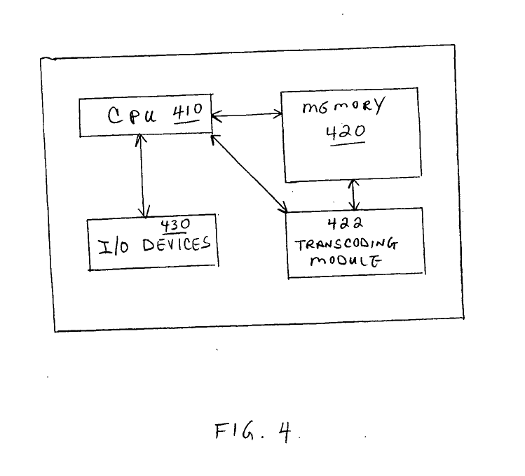

In one embodiment, the transitions or splice points between the primary streams and the secondary streams are evaluated to determine whether black frames and/or mute audio frames are to be inserted into the transitions or splice points of the spliced streams. The methods for inserting these black frames and/or mute audio frames are further described below with reference to FIGS. 2 and 3.

The transcode processing element TPE 110 may also partially decode the incoming video bit streams. For example, the TPE may send the complexity, frame type information and the transcode output FIFO level to the quantization level processor (QLP) 120. Such information will allow the quantization level processor 120 to perform rate control. Broadly speaking, rate control may comprise the ability to assign a target frame size (e.g., a target number bits to encode a frame) for each frame and/or the ability to assign a transmission data rate for a particular channel. In one embodiment, the transmission data rate for each channel 115 can be variable, whereas the transport rate or group bandwidth on path 135 is fixed. One exemplary implementation of the QLP is disclosed in WIPO published application WO 02/28108 A2, published on Apr. 4, 2002, which is commonly assigned to the Assignee of the present invention and is herein incorporated by reference.

In one embodiment, the complexity is measured by the product of the quantization level and the input frame size of a frame. Namely, the product of the average quantization scale and the number of bits previously used to encode the frame will provide insights as to the complexity of the frame. Such information will assist the QLP 120 in determining a transcoding target frame size (e.g., the number of target bits for transcoding the frame) and the transmission data rate for one or more frames that are to be transcoded.

It should be noted that the QLP is also tasked with maintaining the virtual decoder buffer fullness to avoid underflow or overflow. To maximize usage of the available channel bandwidth and the quality of the video, the encoder (in this instance, the transcoder 118) seeks to match the number of bits it produces to the available channel bandwidth. This is often accomplished by selecting a target number of bits to be used for the representation of the video frames. The target number of bits is referred to as the target bit allocation. The target bit allocation may be substantially different from picture to picture, based upon picture type and other considerations. A further consideration for the transcoder in generating bits is the capacity of any buffers in the system. Generally, since the bitrates of the encoder and decoder are not constant, there are buffers placed at both ends of the channel, one following the encoder prior to the channel and one at the end of the channel preceding the decoder. The buffers are employed to absorb the fluctuation in the bitrates. However, the QLP often must insure that the buffers at the encoder and decoder will not overflow or underflow as a result of the bit stream generated.

As discussed above, the lack of time synchronization between the primary stream and the secondary stream may create gaps in the transition points of the spliced stream that must be addressed so that time synchronization is not lost with respect to the decoder. In one embodiment, during the splice transitions from the advertisement program to the primary program, up to one second of black video sequence and mute audio frames are inserted to bridge the time gap between the two programs. For example, the time gap is the time period from the splice point program time stamp (PTS) embedded in the cue tone message to the PTS of the first I-frame of the primary program. In one embodiment, the black video sequence comprises a black I-frame followed by a sequence of repeat P-frames. The number of repeat P-frames depends on the length of the time gap. Additionally, a sequence of mute audio frames may also be inserted during the time gap for the audio transitions. For example, the black frames and the mute audio frames are shown in FIG. 1 as been stored on a black sequence buffer 114a and mute audio sequence buffer 114b.

It should be noted that the black video sequence is a minimum frame size sequence. In other words, it comprises only non-coded blocks. During the time gap of up to one second, the transcoding target frame size is not being used and the black video sequence is simply bypassed through the transcoder 118. However, the MUX 130 still pulls out the video stream from transcoder output FIFO 118a at the calculated transmission data rate. The mismatch between the transcode bit rate on path 115 and the transmission data rate on path 135 may lead to the video decoder buffer underflow during the splice transitions. For example, the mismatch may be caused by the incorrect complexity measurement for minimum frame size video sequence. Since such mismatch should be avoided, the insertion of the black frames are performed in a manner to minimize such mismatch as discussed below.

FIG. 2 is a flowchart of a method 200 for inserting black frames in accordance with the present invention. Method 200 starts in step 205 and proceeds to step 210.

In step 210, method 200 determines or detects a splice point between two streams, e.g., between a primary stream and a secondary stream in elementary stream buffer 116. It should be noted that the splice point can be the point where a secondary stream starts or the point where a secondary stream ends.

In step 220, method 200 determines whether a gap exists at the splice point. It should be noted that such gap can be due to the lack of time synchronization between the primary stream and the secondary stream at the splice point. Alternatively, the gap can be arbitrarily defined in accordance with a particular implementation. If the query is negatively answered, then method 200 ends in step 235. If the query is positively answered, then method proceeds to step 230.

In step 230, method 200 inserts one or more black frames in the gap. Black frame is broadly defined as frames containing no information, e.g., where each pixel in the frame is set at a predefined luminance value. For example, the luminance value is selected such that when the frame is displayed, a “black” frame is displayed. It should be noted that the frame need not be absolutely black. Any predefined luminance value that can be selected to generate a relatively black frame as perceived by a viewer is contemplated within the scope of the present invention.

The present invention discloses a number of different embodiments of black frames that can be inserted at the gap of the spliced stream. In one embodiment, the frame types of the black frames are chosen to minimize the size of the black frames. Specifically, the black video sequence comprises a black I-frame followed by a sequence of repeat P-frames. The number of repeat P-frames depends on the length of the time gap between the PTS embedded in the cue tone message and the PTS of the first I-frame of the primary program. The repeat P-frames are frame repeat pictures.

In a second embodiment, the resolution of the black frames is chosen to minimize the size of the black frames. Specifically, the black frame sequence is a reduced resolution (e.g., half resolution) that is less than the resolution of the frames in the primary and secondary streams. For example, if the resolution of the primary and/or secondary streams is at 704 pixels across, then the resolution of the black frames can be selected to be 352 pixels across.

Thus, the reduced resolution of the black frames is selected regardless of the resolutions of the two programs in transition. A sequence header and a sequence extension can be added to the black I-frame to indicate the resolution change.

In a third embodiment, the quantization level or scale of the black frames is chosen to optimize the transmission data rate. It should be noted that the decoder does not use the quantization level for black frames because the black video sequence comprises only non-coded blocks. However, as discussed above, the transcoder 118 will typically extract the quantization level and send it to the QLP 120 as a complexity measure. Since each black frame requires only a small number of bits to carry the information within the black frame, the QLP may attempt to severely change the transmission data rate when the QLP encounters such black frames. In other words, the QLP may properly detect the low complexity of the black frames and attempts to set a lower target frame rate for the black frame and also reduces the transmission data rate. Unfortunately, setting a lower target frame size for a black frame is inappropriate because the black frame comprises only non-coded blocks, i.e., the transcoder 118 will be unable to meet a lower target frame size selected for the black frame by the QLP 120. Furthermore, changing the transmission data rate too low may affect the transmission of the spliced stream when the black fame sequence ends. Thus, in one embodiment, a quantization scale is selected at a level, e.g., a value of 20 in one instance, for the black frame such that an optimal transmission data rate is maintained to support the transition from the black frames to the primary program. It should be noted that the selected value for the quantization scale is application specific and is not limited to the value 20.

FIG. 3 is a flowchart of a method 300 for inserting mute audio frames in accordance with the present invention. Method starts in step 305 and proceeds to step 310.

In step 310, method 300 determines or detects a splice point between two streams, e.g., between a primary stream and a secondary stream in delay buffer 117. It should be noted that the splice point can be the point where a secondary stream starts or the point where a secondary stream ends.

In step 320, method 300 determines whether a gap exists at the splice point. Again, it should be noted that such gap can be due to the lack of time synchronization between the primary stream and the secondary stream at the splice point. Alternatively, the gap can be arbitrarily defined in accordance with a particular implementation. If the query is negatively answered, then method 300 ends in step 335. If the query is positively answered, then method proceeds to step 330.

In step 330, method 300 inserts one or more mute audio frames in the gap. Mute audio frame is broadly defined as audio frames containing no audio information, e.g., where the audio level of each subband is set to a very low level. For example, the value is selected such that when the audio frame is played, an undetectable audio level is played. It should be noted that the audio frame need not be absolutely silent. Any predefined value that can be selected to generate a relatively mute audio frame as perceived by a listener is contemplated within the scope of the present invention.

The present invention discloses a number of different embodiments of audio mute frames that can be inserted at the gap of the spliced stream. Namely, a sequence of mute audio frames is also inserted during the time gap for the audio transitions. In one embodiment, the audio bit rate is chosen to minimize the size of the mute frames. Specifically, the mute audio frame sequence is at a lower bit rate (e.g., 92 kbps) that is less than the bit rate of the audio frames in the primary and secondary streams. For example, if the bit rate of the primary and/or secondary streams is at 256 kbps, then the bit rate of the mute audio frames can be selected to be 92 kbps. Thus, a low bit rate of 92 kbps is chosen for the mute audio sequence regardless of the audio bit rates of the two programs in transition.

In an alternative embodiment, the audio transmission data rate is chosen to protect the decoder buffer. Specifically, each audio transport packet is attached with a hardware time tag, preferably in 27 MHz ticks, that indicates the time for the packet to be pulled out the delay 117. The hardware time tag of a transport packet is initially set to the time it arrives and is modified later if necessary. As such, the audio transmission data rate depends on the hardware time tag attached to each audio transport packet by the TPE. Therefore, it is possible to alter the hardware time tag of the mute audio frames such that the audio transmission data rate is increased, e.g., by 50 percent during the splice transitions to build up the decoder buffer fullness to avoid decoder buffer underflow when returning to the primary program. Namely, the splicer establishes a target decoder buffer delay at the time to splice into the advertisement program. It also maintains the target decoder buffer delay throughout the advertisement insertion period so that, at the end of the advertisement insertion, the audio decoder buffer fullness is high enough to accommodate the primary program without altering the original fullness. This is only true when the audio bit rates of the two programs are not too different. If the audio bit rate of the advertisement program is much higher than that of primary program, for example, two times higher, the target decoder buffer delay is limited by the maximum decoder buffer fullness. In such cases, the target decoder buffer delay may not be big enough at the end of the advertisement insertion, which may cause the audio decoder buffer to underflow during the splice transitions.

It should be noted that the demultiplexer 112, the elementary stream buffer 116, the delay duffer 117, the black sequence buffer 114a and the mute audio sequence buffer 114b can be broadly described as a splicer that performs the splicing function(s) as discussed above. However, those skilled in the art will realize that the splicer can include more or less elements to perform the functions as described above. As such, the splicer is not limited to the elements as disclosed in FIG. 1.

FIG. 4 is a block diagram of the present digital transcoding system being implemented with a general purpose computer. FIG. 4 is a block diagram of the present digital scheduling system being implemented with a general purpose computer. In one embodiment, the digital transcoding system 100 is implemented using a general purpose computer or any other hardware equivalents. More specifically, the digital transcoding system 100 comprises a processor (CPU) 410, a memory 420, e.g., random access memory (RAM) and/or read only memory (ROM), and a digital transcoding module, engine, manager or application 422, and various input/output devices 430 (e.g., storage devices, including but not limited to, a tape drive, a floppy drive, a hard disk drive or a compact disk drive, a receiver, a transmitter, a speaker, a display, an output port, a user input device (such as a keyboard, a keypad, a mouse, and the like), or a microphone for capturing speech commands).

It should be understood that the digital transcoding module, engine, manager or application 422 can be implemented as a physical device or subsystem that is coupled to the CPU 410 through a communication channel. Alternatively, the digital transcoding module, engine, manager or application 422 can be represented by one or more software applications (or even a combination of software and hardware, e.g., using application specific integrated circuits (ASIC)), where the software is loaded from a storage medium (e.g., a magnetic or optical drive or diskette) and operated by the CPU in the memory 420 of the computer. As such, the digital transcoding module, engine, manager or application 422 (including associated data structures) of the present invention can be stored on a computer readable medium or carrier, e.g., RAM memory, magnetic or optical drive or diskette and the like.

Although the present invention is described within the context of MPEG, those skilled in the art will realize that the present invention can be equally applied to other encoding standards, such as MPEG-1, MPEG-2, MPEG-4, H.261, H.263, and the like. Additionally, although the present invention discusses frames in the context of I, P, and B frames of MPEG, the present invention is not so limited. An I-frame is broadly defined as an intra coded picture. A P-frame is broadly defined as a predictive-coded picture and a B-frame is broadly defined as a bi-directionally predictive-coded picture. These types of frames may exist in other encoding standards under different names.

Furthermore, although the present invention is described from the perspective of a transcoding system, the present invention is not so limited. Namely, the image processing steps as disclosed in the transcoding side will necessarily cause a complementary processing step on the decoder side. For example, inserting black frames on the transcoding side will cause the decoder to decode the inserted black frames and to display those black frames. Thus, although not specifically shown, those skilled in the art will realize that a decoder can be implemented to perform the complementary steps as discussed above.

While the foregoing is directed to embodiments of the present invention, other and further embodiments of the invention may be devised without departing from the basic scope thereof, and the scope thereof is determined by the claims that follow.

1. A method for generating a spliced stream, comprising:
splicing a first stream with a second stream to form the spliced stream; and
inserting at least one black frame at one or more splice points of said spliced stream.

2. The method of claim 1, wherein said at least one black frame comprises a sequence of black frames, where a first black frame of said sequence of black frames is an I frame followed by at least one P frame.

3. The method of claim 1, wherein said at least one black frame is at a reduced resolution relative a resolution of a plurality of frames of said first stream and said second stream.

4. The method of claim 1, wherein a quantization scale is selected for said at least one black frame.

5. The method of claim 4, wherein said quantization scale is selected in accordance with a transmission data rate appropriate for at least said first stream.

6. The method of claim 1, further comprising:
inserting at least one mute audio frame at one or more splice points of said spliced stream.

7. The method of claim 6, wherein said at least one mute audio frame is at a reduced audio bit rate relative an audio bit rate of a plurality of audio frames of said first stream and said second stream.

8. The method of claim 7, wherein each of said at least one mute audio frame has a time stamp that is selected to increase an audio transmission rate.

9. An apparatus for generating a spliced stream, comprising:
means for splicing a first stream with a second stream to form the spliced stream; and
means for inserting at least one black frame at one or more splice points of said spliced stream.

10. The apparatus of claim 9, wherein said at least one black frame comprises a sequence of black frames, where a first black frame of said sequence of black frames is an I frame followed by at least one P frame.

11. The apparatus of claim 9, wherein said at least one black frame is at a reduced resolution relative a resolution of a plurality of frames of said first stream and said second stream.

12. The apparatus of claim 9, wherein a quantization scale is selected for said at least one black frame.

13. The apparatus of claim 12, wherein said quantization scale is selected in accordance with a transmission data rate appropriate for at least said first stream.

14. The apparatus of claim 9, further comprising:
means for inserting at least one mute audio frame at one or more splice points of said spliced stream.

15. The apparatus of claim 14, wherein said at least one mute audio frame is at a reduced audio bit rate relative an audio bit rate of a plurality of audio frames of said first stream and said second stream.

16. The apparatus of claim 15, wherein each of said at least one mute audio frame has a time stamp that is selected to increase an audio transmission rate.

17. A computer readable carrier including program instructions that instruct a computer to perform a method of generating a spliced stream, comprising:
splicing a first stream with a second stream to form the spliced stream; and
inserting at least one black frame at one or more splice points of said spliced stream.

18. The computer readable carrier of claim 17, wherein said at least one black frame comprises a sequence of black frames, where a first black frame of said sequence of black frames is an I frame followed by at least one P frame.

19. The computer readable carrier of claim 17, wherein said at least one black frame is at a reduced resolution relative a resolution of a plurality of frames of said first stream and said second stream.

20. The computer readable carrier of claim 17, wherein a quantization scale is selected for said at least one black frame.

21. The computer readable carrier of claim 20, wherein said quantization scale is selected in accordance with a transmission data rate appropriate for at least said first stream.

22. The computer readable carrier of claim 17, further comprising:
inserting at least one mute audio frame at one or more splice points of said spliced stream.

23. The computer readable carrier of claim 22, wherein said at least one mute audio frame is at a reduced audio bit rate relative an audio bit rate of a plurality of audio frames of said first stream and said second stream.

24. The computer readable carrier of claim 23, wherein each of said at least one mute audio frame has a time stamp that is selected to increase an audio transmission rate.

25. A method for generating a spliced stream, comprising:
splicing a first stream with a second stream to form the spliced stream; and
inserting at least one mute audio frame at one or more splice points of said spliced stream.
